(19) United States
(12) Patent Application Publication
(10) Pub. No.: US 2024/0069190 A1
(43) Pub. Date: Feb. 29, 2024

(54) WIND SPEED PREDICTION DEVICE, WIND SPEED PREDICTION METHOD, AND RADAR DEVICE

(71) Applicant: MITSUBISHI ELECTRIC CORPORATION, Tokyo (JP)

(72) Inventors: Takayuki KITAMURA, Tokyo (JP); Kei SUWA, Tokyo (JP); Shumpei KAMEYAMA, Tokyo (JP); Hiroshi SAKAMAKI, Tokyo (JP); Masaharu IMAKI, Tokyo (JP)

(73) Assignee: MITSUBISHI ELECTRIC CORPORATION, Tokyo (JP)

(21) Appl. No.: 18/387,175

(22) Filed: Nov. 6, 2023

Related U.S. Application Data
(63) Continuation of application No. PCT/JP2021/023291, filed on Jun. 21, 2021.

(51) Int. Cl. G01S 13/95

(52) U.S. Cl. CPC G01S 13/95

(57) ABSTRACT

A wind speed prediction device includes processing circuitry configured to acquire a scattering signal that is each of a plurality of beams after being emitted to space and scattered in the space; variably set a range bin width as distance resolution of each of the acquired scattering signals in accordance with an elevation angle of each of the beams emitted to the space, and calculate at least one Doppler frequency of at least one range bin corresponding to a two-dimensional plane including an observation region from the each of the scattering signals; estimate at least one wind speed distribution in the two-dimensional plane from the plurality of Doppler frequencies calculated; and predict a wind speed in the observation region from the at least one wind speed distribution in the two-dimensional plane using a two-dimensional Navier-Stokes equation.

### CROSS REFERENCE TO RELATED APPLICATIONS

This application is a Continuation of PCT International Application No. PCT/JP2021/023291, filed on Jun. 21, 2021, which is hereby expressly incorporated by reference into the present application.

### TECHNICAL FIELD

The present disclosure relates to a wind speed prediction device, a wind speed prediction method, and a radar device.

### BACKGROUND ART

Some wind speed prediction devices that predict a wind speed in an observation region include a wind speed prediction device (hereinafter referred to as a “conventional wind speed prediction device”) that predicts a wind speed in an observation region by simulating the wind speed using a weather model (see Patent Literature 1). The simulation of the wind speed is three-dimensional calculation processing.

### CITATION LIST

### Patent Literatures

Patent Literature 1: Japanese Patent Application Laid-Open No. 2014-202190

### SUMMARY OF INVENTION

### Technical Problem

The conventional wind speed prediction device disclosed in Patent Literature 1 performs three-dimensional calculation processing, and thus has a problem that a calculation load may increase.

The present disclosure has been made to solve the above problems, and an object thereof is to obtain a wind speed prediction device and a wind speed prediction method capable of predicting a wind speed without performing three-dimensional calculation processing.

### Solution To Problem

A wind speed prediction device according to the present disclosure includes processing circuitry configured to acquire a scattering signal that is each of a plurality of beams after being emitted to space and scattered in the space, the beams having mutually different elevation angles, which are angles formed by a line-of-sight direction and a horizontal direction, variably set a range bin width as distance resolution of each of scattering signals having been acquired in accordance with an elevation angle of each of the beams emitted to the space to enable monitoring of an observation point at a same altitude even by a beam having a different elevation angle, and calculate at least one Doppler frequency of at least one range bin corresponding to a two-dimensional plane including an observation region from the each of the scattering signals, the at least one Doppler frequency including a plurality of Doppler frequencies, estimate at least one wind speed distribution in the two-dimensional plane from the plurality of Doppler frequencies having been calculated using a volume velocity processing (VVP) method, and predict a wind speed in the observation region from the estimated at least one wind speed distribution in the two-dimensional plane using a two-dimensional Navier-Stokes equation.

### Advantageous Effects of Invention

According to the present disclosure, a wind speed can be predicted without performing three-dimensional calculation processing.

### BRIEF DESCRIPTION OF DRAWINGS

FIG. 1 is a configuration diagram illustrating a radar device 1 including a wind speed prediction device 3 according to a first embodiment.

FIG. 2A is an explanatory diagram illustrating a plurality of beams in a case where the position of a flight area is directly above a beam transmitting and receiving unit 2 in a vertical direction, and FIG. 2B is an explanatory diagram illustrating a plurality of beams in a case where the position of the flight area is deviated from directly above the beam transmitting and receiving unit 2 in the vertical direction.

FIG. 3 is a configuration diagram illustrating a wind speed prediction device 3 according to the first embodiment.

FIG. 4 is a hardware configuration diagram illustrating hardware of the wind speed prediction device 3 according to the first embodiment.

FIG. 5 is a hardware configuration diagram of a computer in a case where the wind speed prediction device 3 is implemented by software, firmware, or the like.

FIG. 6 is a flowchart illustrating a wind speed prediction method which is a processing procedure performed by the wind speed prediction device 3.

FIG. 7A is an explanatory diagram illustrating that altitudes of a plurality of observation points of the same range bin Rbₘ are different from each other when an elevation angle θₙ is different, and FIG. 7B is an explanatory diagram illustrating that a plurality of observation points of the same range bin Rbₘ are at the same altitude even when the elevation angle θₙ is changed.

FIG. 8 is an explanatory diagram illustrating positions (x, y, z) of observation points of the wind speed.

FIG. 9 is a configuration diagram illustrating a wind speed prediction device 3 according to a second embodiment.

FIG. 10 is a hardware configuration diagram illustrating hardware of the wind speed prediction device 3 according to the second embodiment.

FIG. 11 is a configuration diagram illustrating a wind speed prediction device 3 according to a third embodiment.

FIG. 12 is a hardware configuration diagram illustrating hardware of the wind speed prediction device 3 according to the third embodiment.

### DESCRIPTION OF EMBODIMENTS

Hereinafter, in order to describe the present disclosure in more detail, modes for carrying out the present disclosure will be described with reference to the accompanying drawings.

### First Embodiment

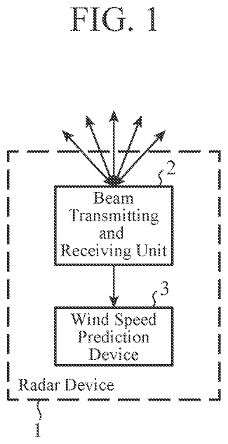

FIG. 1 is a configuration diagram illustrating a radar device 1 including a wind speed prediction device 3 according to a first embodiment.

The radar device 1 illustrated in FIG. 1 includes a beam transmitting and receiving unit 2 and a wind speed prediction device 3.

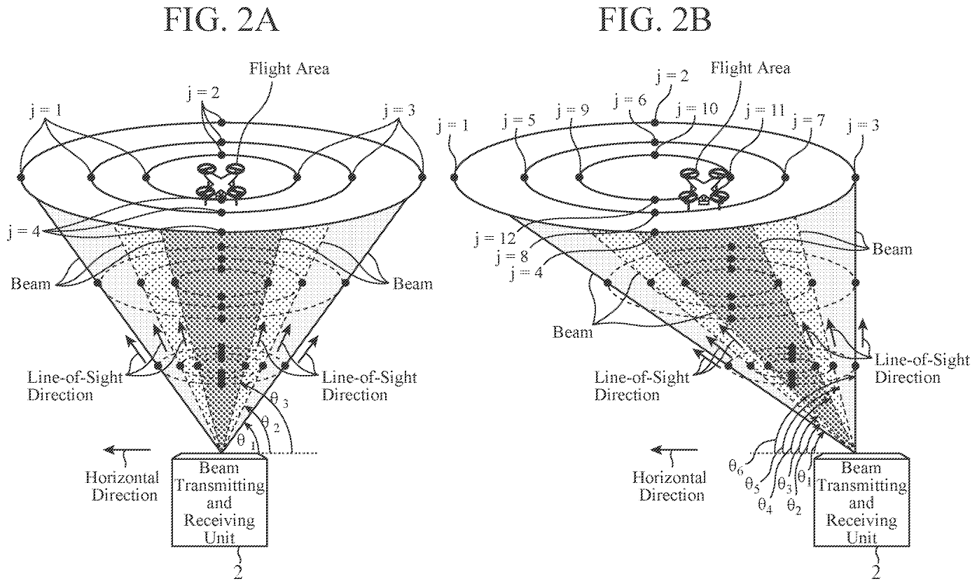

FIG. 2 is an explanatory diagram illustrating a plurality of beams emitted to space from the beam transmitting and receiving unit 2. In the example of FIG. 2, the observation region is present in the space. The observation region is, for example, a flight area in which a flying object is scheduled to fly. The flying object is, for example, a drone or a helicopter.

FIG. 2A is an explanatory diagram illustrating a plurality of beams in a case where the position of the flight area is directly above the beam transmitting and receiving unit 2 in the vertical direction.

FIG. 2B is an explanatory diagram illustrating a plurality of beams in a case where the position of the flight area is deviated from directly above the beam transmitting and receiving unit 2 in the vertical direction.

The beam transmitting and receiving unit 2 includes, for example, a beam generating unit, a beam transmitter, a radiation direction switching unit, an antenna, and a beam receiver. In FIG. 1, notations of the beam generating unit, the beam transmitter, the radiation direction switching unit, the antenna, and the beam receiver are omitted.

As illustrated in FIG. 2, the beam transmitting and receiving unit 2 emits each of a plurality of beams having mutually different elevation angles θₙ (n=1, . . . , N), which are angles formed by the line-of-sight direction and the horizontal direction, into space. N is an integer of 2 or more.

That is, as illustrated in FIG. 2A, when the flight area is present directly above in the vertical direction, the beam transmitting and receiving unit 2 emits beams in different directions at respective elevation angles On by performing beam scanning at the respective elevation angles On.

In FIG. 2A, N=3, and each of the beam with the elevation angle θ₁, the beam with the elevation angle θ₂, and the beam with the elevation angle θ₃ is emitted from the beam transmitting and receiving unit 2 to space. In FIG. 2A, beams are emitted in four directions at the respective elevation angles θₙ . In FIG. 2A, black circles indicate observation points of the wind speed.

Further, as illustrated in FIG. 2B, when the position of the flight area is deviated from directly above in the vertical direction, the beam transmitting and receiving unit 2 emits beams at respective elevation angles On while switching the elevation angles θₙ .

In FIG. 2B, N=12, and beams of elevation angles θ₁ to θ₁₂ are emitted from the beam transmitting and receiving unit 2 to space. For simplification of the drawing, only the elevation angles θ₁ to θ₆ are illustrated in FIG. 2B, and the illustration of the elevation angles θ₇ to θ₁₂ is omitted. In FIG. 2B, a beam is emitted in one direction at each elevation angle θₙ. In FIG. 2B, black circles indicate observation points of the wind speed.

Each of FIGS. 2A and 2B illustrates an example of obtaining wind speed distributions in three two-dimensional planes. However, this is merely an example, and wind speed distributions in one or two two-dimensional planes may be obtained, or wind speed distributions in four or more two-dimensional planes may be obtained.

As the beam emitted from the beam transmitting and receiving unit 2, for example, in addition to continuous wave (CW) pulsed light, frequency-modulated pulsed light can be used.

The beam transmitting and receiving unit 2 receives each beam scattered in space as a scattering signal.

The beam transmitting and receiving unit 2 converts each scattering signal from an analog signal to a digital signal, and outputs the digital signal to the wind speed prediction device 3.

Further, the beam transmitting and receiving unit 2 outputs angle information indicating the elevation angle θₙ of each beam emitted to space to the wind speed prediction device 3.

In the radar device 1 illustrated in FIG. 1, it is assumed that the beam transmitting and receiving unit 2 includes a beam generating unit, a beam transmitter, a radiation direction switching unit, an antenna, and a beam receiver. However, the beam transmitting and receiving unit 2 is only required to emit each of a plurality of beams having different elevation angles θₙ into space and receive each beam scattered in the space as a scattering signal, and may have any configuration.

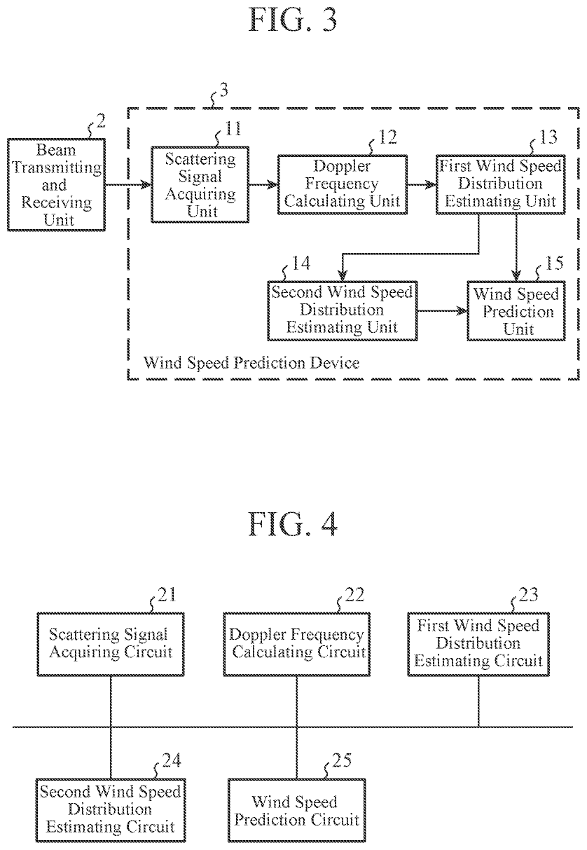

FIG. 3 is a configuration diagram illustrating the wind speed prediction device 3 according to the first embodiment.

FIG. 4 is a hardware configuration diagram illustrating hardware of the wind speed prediction device 3 according to the first embodiment.

The wind speed prediction device 3 illustrated in FIG. 3 includes a scattering signal acquiring unit 11, a Doppler frequency calculating unit 12, a first wind speed distribution estimating unit 13, a second wind speed distribution estimating unit 14, and a wind speed prediction unit 15.

The scattering signal acquiring unit 11 is implemented by, for example, a scattering signal acquiring circuit 21 illustrated in FIG. 4.

The scattering signal acquiring unit 11 acquires each of digital signals Sθ_{n,j}(t) from the beam transmitting and receiving unit 2 as each of scattering signals after being scattered in space. j=, . . . , J. j is the scan number of beam scanning at the elevation angle θₙ. In the example of FIG. 2A, since beams are emitted in four directions at each elevation angle θₙ, J =4. In the example of FIG. 2B, since the beam is emitted in one direction at each elevation angle θₙ, J=1. t is a variable indicating time.

Further, the scattering signal acquiring unit 11 acquires the angle information indicating the elevation angle θₙ of each beam emitted into space by the beam transmitting and receiving unit 2.

The scattering signal acquiring unit 11 outputs each of the digital signals sθ_{n,j}(t) and the angle information to the Doppler frequency calculating unit 12.

The Doppler frequency calculating unit 12 is implemented by, for example, a Doppler frequency calculating circuit 22 illustrated in FIG. 4.

The Doppler frequency calculating unit 12 acquires each of the digital signals sθ_{n,j} (t) and the angle information from the scattering signal acquiring unit 11.

Before performing fast Fourier transformation (FFT) on each digital signal sθ_{n,j}(t) in the hit direction, the Doppler frequency calculating unit 12 sets a range bin width as the distance resolution of each digital signal sθ_{n,j}(t) according to the elevation angle θₙ indicated by the angle information. That is, the Doppler frequency calculating unit 12 sets an FFT length L_{θn} corresponding to the range bin width.

The FFT length L_{θn} is set shorter as the elevation angle θₙ of the beam emitted to space is wider, and is set longer as the elevation angle θₙ of the beam emitted to the space is narrower.

In the example of FIG. 2A, the FFT length L_{θ1} of the digital signal s_{θ1,j}(t) corresponding to the beam at the elevation angle θ₁ is longer than the FFT length L_{θ2} of the digital signal s_{θ2,j}(t) corresponding to the beam at the elevation angle θ₂, and the FFT length Lee of the digital signal s_{θ2,j}(t) corresponding to the beam at the elevation angle θ₂ is longer than the FFT length L_{θ3} of the digital signal s_{74 3,j}(t) corresponding to the beam at the elevation angle θ₃.

The Doppler frequency calculating unit 12 converts each of the digital signals s_{θn,j}(t) into frequency domain signals r_{θn,j}(f) by performing FFT on the digital signals s_{θn,j}(t) acquired by the scattering signal acquiring unit 11 in the hit direction. f is a variable indicating a frequency.

The Doppler frequency calculating unit 12 calculates the respective Doppler frequencies dpf_{θn,j,Rbm} in a plurality of range bins Rb₁ to Rb_{M} from the signals r_{θn,j}(f) in the frequency domain. m=1, . . . , M, and M is an integer of 1 or more.

FIG. 2 illustrates an example of obtaining wind speed distributions in three two-dimensional planes. As illustrated in FIG. 2, in a case of obtaining wind speed distributions in three two-dimensional planes, the Doppler frequency calculating unit 12 calculates the Doppler frequencies dpf_{θn,j,Rbm} in the range bins Rb₁, Rb₂, and Rb₃ from the signals r_{θn,j}(f) in the frequency domain.

In the wind speed prediction device 3 illustrated in FIG. 3, it is assumed that M is an integer of 2 or more. Here, M is not limited to an integer of 2 or more, and M =1 may be set.

When M=1, the Doppler frequency calculating unit 12 calculates only the Doppler frequency dpf_{θn,j,Rb1} of one range bin Rb₁ including the observation region from the frequency domain signal r_{θn,j}(f).

The Doppler frequency calculating unit 12 outputs the Doppler frequencies dpf_{θn,j,Rbm} of the respective range bins Rbₘ to the first wind speed distribution estimating unit 13.

The first wind speed distribution estimating unit 13 is implemented by, for example, a first wind speed distribution estimating circuit 23 illustrated in FIG. 4.

The first wind speed distribution estimating unit 13 estimates a wind speed distribution u_{Rbm}(x, y) in a two-dimensional plane corresponding to each range bin Rbₘ using a volume velocity processing (VVP) method from a plurality of Doppler frequencies dpf_{θ1,j,Rbm} to dpf_{θN,j,Rbm} in each range bin Rbₘ calculated by the Doppler frequency calculating unit 12.

When M is 1, the first wind speed distribution estimating unit 13 estimates the wind speed distribution u_{Rb1}(x, y) in the two-dimensional plane corresponding to the range bin Rb₁ as the two-dimensional plane including the observation region, and outputs the wind speed distribution u_{Rb1}(x, y) in the two-dimensional plane to the wind speed prediction unit 15.

When M is 2 or more, the first wind speed distribution estimating unit 13 outputs the wind speed distribution u_{Rbm}(x, y) in the two-dimensional plane corresponding to each range bin Rbₘ to the second wind speed distribution estimating unit 14.

The second wind speed distribution estimating unit 14 is implemented by, for example, a second wind speed distribution estimating circuit 24 illustrated in FIG. 4.

The second wind speed distribution estimating unit 14 estimates a wind speed distribution u_{Rbm′}(x, y) in a two-dimensional plane between a plurality of two-dimensional planes from the wind speed distributions u_{Rb1}(x, y) to u_{RbM}(x, y) in the plurality of two-dimensional planes estimated by the first wind speed distribution estimating unit 13. For example, the wind speed distribution u_{Rb1}(x, y) in the two-dimensional plane is a wind speed distribution in the two-dimensional plane between the two-dimensional plane corresponding to the range bin Rb₁ and the two-dimensional plane corresponding to the range bin Rb₂. The wind speed distribution u_{Rb2′}(x, y) in the two-dimensional plane is a wind speed distribution in the two-dimensional plane between the two-dimensional plane corresponding to the range bin Rb₂ and the two-dimensional plane corresponding to the range bin Rb₃.

The second wind speed distribution estimating unit 14 outputs the wind speed distributions u_{Rb1′}(x, y) to u_{RbM-1′}(x, y) in the two-dimensional plane between the plurality of two-dimensional planes to the wind speed prediction unit 15.

The wind speed prediction unit 15 is implemented by, for example, a wind speed prediction circuit 25 illustrated in FIG. 4.

When M is 1, the wind speed prediction unit 15 predicts a wind speed u(t) in the observation region from the wind speed distribution u_{Rb1}(x, y) in the two-dimensional plane estimated by the first wind speed distribution estimating unit 13 using the two-dimensional Navier-Stokes equation (hereinafter referred to as a “two-dimensional N-S equation”). The observation region is, for example, an area including a flight area in which the flying object is scheduled to fly.

When M is 2 or more, the wind speed prediction unit 15 selects the wind speed distribution in the two-dimensional plane including the flight area as the observation region from the wind speed distributions u_{Rb1}(x, y) to u_{RbM}(x, y) in the plurality of two-dimensional planes estimated by the first wind speed distribution estimating unit 13 and the wind speed distributions u_{Rb1′}(x, y) to u_{RbM-1′}(x, y) in the two-dimensional plane estimated by the second wind speed distribution estimating unit 14.

The wind speed prediction unit 15 predicts the wind speed u(t) in the flight area from the wind speed distribution in the selected two-dimensional plane using the two-dimensional N-S equation.

In FIG. 3, it is assumed that each of the scattering signal acquiring unit 11, the Doppler frequency calculating unit 12, the first wind speed distribution estimating unit 13, the second wind speed distribution estimating unit 14, and the wind speed prediction unit 15, which are components of the wind speed prediction device 3, is implemented by dedicated hardware as illustrated in FIG. 4. That is, it is assumed that the wind speed prediction device 3 is implemented by the scattering signal acquiring circuit 21, the Doppler frequency calculating circuit 22, the first wind speed distribution estimating circuit 23, the second wind speed distribution estimating circuit 24, and the wind speed prediction circuit 25.

Each of the scattering signal acquiring circuit 21, the Doppler frequency calculating circuit 22, the first wind speed distribution estimating circuit 23, the second wind speed distribution estimating circuit 24, and the wind speed prediction circuit 25 corresponds to, for example, a single circuit, a composite circuit, a programmed processor, a parallel-programmed processor, an application specific integrated circuit (ASIC), a field-programmable gate array (FPGA), or a combination thereof.

The components of the wind speed prediction device 3 are not limited to those implemented by dedicated hardware, and the wind speed prediction device 3 may be implemented by software, firmware, or a combination of software and firmware.

Software or firmware is stored in a memory of the computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

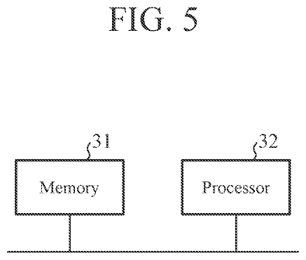

FIG. 5 is a hardware configuration diagram of a computer in a case where the wind speed prediction device 3 is implemented by software, firmware, or the like.

In a case where the wind speed prediction device 3 is implemented by software, firmware, or the like, a program for causing a computer to execute each processing procedure performed in the scattering signal acquiring unit 11, the Doppler frequency calculating unit 12, the first wind speed distribution estimating unit 13, the second wind speed distribution estimating unit 14, and the wind speed prediction unit 15 is stored in a memory 31. Then, a processor 32 of the computer executes the program stored in the

Further, FIG. 4 illustrates an example in which each of the components of the wind speed prediction device 3 is implemented by dedicated hardware, and FIG. 5 illustrates an example in which the wind speed prediction device 3 is implemented by software, firmware, or the like. However, this is merely an example, and some components in the wind speed prediction device 3 may be implemented by dedicated hardware, and the remaining components may be implemented by software, firmware, or the like.

Next, the operation of the radar device 1 illustrated in FIG. 1 will be described.

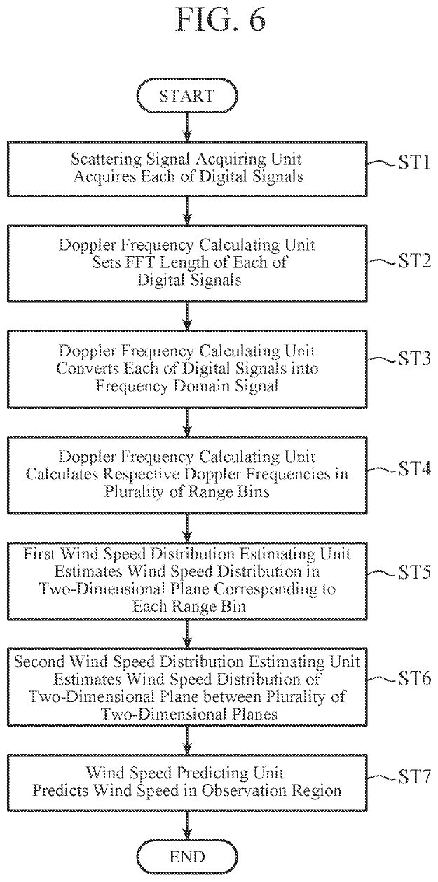

FIG. 6 is a flowchart illustrating a wind speed prediction method which is a processing procedure performed by the wind speed prediction device 3.

As illustrated in FIG. 2, the beam transmitting and receiving unit 2 emits each of a plurality of beams having different elevation angles θₙ (n=1, . . . , N) to space.

That is, as illustrated in FIG. 2A, when the flight area is present directly above in the vertical direction, the beam transmitting and receiving unit 2 emits beams in different directions at respective elevation angles θₙ by performing beam scanning at the respective elevation angles θₙ.

As illustrated in FIG. 2B, when the position of the flight area is deviated from directly above in the vertical direction, the beam transmitting and receiving unit 2 emits beams at respective elevation angles θₙ while switching the elevation angles θₙ. The beam emitted from the beam transmitting and receiving unit 2 is, for example, pulsed light.

Each beam emitted from the beam transmitting and receiving unit 2 is backscattered by fine particles such as aerosol floating in space. For example, when a plurality of fine particles is present in the line-of-sight direction of one beam, one beam is backscattered by each fine particle. The backscattered beam returns to the beam transmitting and receiving unit 2 as a scattering signal. Since the distances from the beam transmitting and receiving unit 2 to the plurality of fine particles are different from each other, the times at which the respective scattering signals return to the beam transmitting and receiving unit 2 are different from each other.

The beam transmitting and receiving unit 2 converts each scattering signal from an analog signal into a digital signal s_{θn,j}(t) (n=1, . . . , N: j=1, . . . , J), and outputs the digital signal s_{θn,j} to the wind speed prediction device 3.

Further, the beam transmitting and receiving unit 2 outputs the angle information indicating the elevation angle θₙ of each beam emitted to space to the wind speed prediction device 3.

The scattering signal acquiring unit 11 acquires each of the digital signals s_{θn,j}(t) from the beam transmitting and receiving unit 2 (step ST1 in FIG. 6).

Further, the scattering signal acquiring unit 11 acquires the angle information indicating the elevation angle θₙ of each beam from the beam transmitting and receiving unit 2.

The scattering signal acquiring unit 11 outputs each of the digital signals s_{θn,j}(t) and the angle information to the Doppler frequency calculating unit 12.

The Doppler frequency calculating unit 12 acquires each of the digital signals s_{θn,j}(t) from the scattering signal acquiring unit 11, and acquires each angle information from the scattering signal acquiring unit 11.

Before FFT each of the digital signals s_{θn,j}(t) in the hit direction, the Doppler frequency calculating unit 12 sets the FFT length L_{74 n} of each of the digital signals s_{θn,j}(t) according to the elevation angle θₙ indicated by the angle information (step ST2 in FIG. 6). The FFT length L_{θn} corresponds to a range bin width of the scattering signal.

That is, the Doppler frequency calculating unit 12 sets the FFT length L_{θn} of the digital signal s_{θn,j}(t) in such a way that the range bin width corresponding to the FFT length L_{θn} is proportional to 1/sin (θₙ).

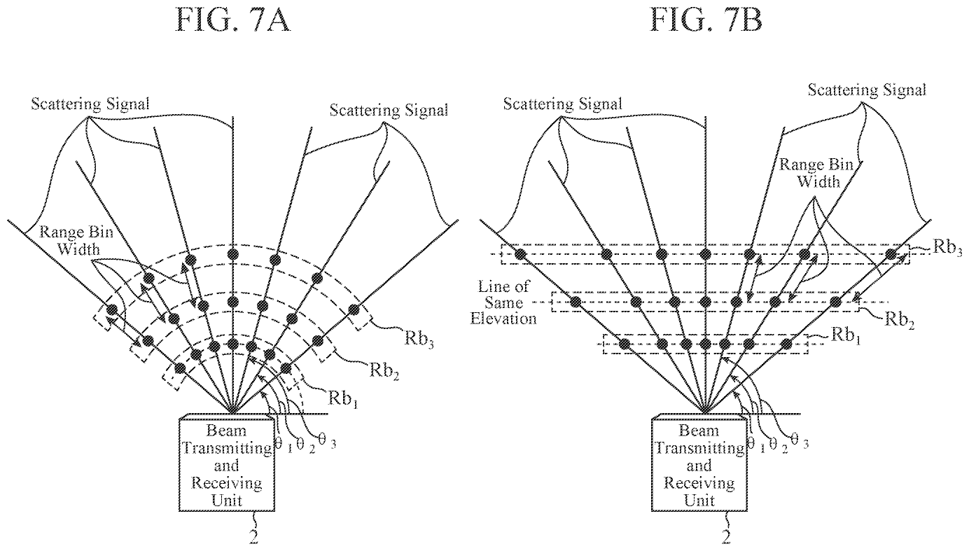

In a case where the FFT lengths Lθₙ of the respective digital signals s_{θn,j}(t) are the same, when the elevation angles θₙ are different, as illustrated in FIG. 7A, the altitudes of a plurality of observation points of the same range bin Rbₘ are different from each other.

On the other hand, in a case where the FFT lengths L_{θn} of the respective digital signals s_{θn,j}(t) are set according to the elevation angle θₙ, as illustrated in FIG. 7B, the altitudes of the plurality of observation points of the same range bin Rbₘ are the same altitude even if the elevation angles θₙ are different.

In the radar device 1 illustrated in FIG. 1, the FFT length L_{θn} is set shorter as the elevation angle θₙ is wider, and the FFT length L_{θn} is set longer as the elevation angle θₙ of the scattering signal is narrower, so that a plurality of observation points in the same range bin Rbₘ have the same altitude.

FIG. 7 is an explanatory diagram illustrating an observation point of the Doppler frequency.

FIG. 7A is an explanatory diagram illustrating that the altitudes of a plurality of observation points of the same range bin Rbₘ are different from each other when the elevation angle θₙ is different.

FIG. 7B is an explanatory diagram illustrating that a plurality of observation points in the same range bin Rbₘ have the same altitude even when the elevation angle θₙ changes.

When the FFT length L_{θn} is set to be short, the width of the range bin Rbₘ becomes narrow and the distance resolution becomes high. On the other hand, when the FFT length L_{θn} is set to be long, the width of the range bin Rbₘ becomes wide and the distance resolution becomes low.

The Doppler frequency calculating unit 12 converts each digital signal s_{θn,j}(t) into a frequency domain signal r_{θn,j}(f) by performing FFT with an FFT length of L_{θn} in the hit direction for each digital signal s_{θn,j}(t) (step ST3 in FIG. 6).

The Doppler frequency calculating unit 12 calculates the respective Doppler frequencies dpf_{θn,j,Rbm} in the plurality of range bins Rb₁ to Rb_{M} from the signals r_{θn,j}(f) in the frequency domain (step ST4 in FIG. 6).

The Doppler frequency calculating unit 12 outputs the Doppler frequencies dpf_{θn,j,Rbm} of the respective range bins Rbₘ to the first wind speed distribution estimating unit 13.

Since the processing itself of calculating the Doppler frequencies dpf_{θn,j,Rbm} of the range bin Rbₘ is a known technique, detailed description thereof will be omitted.

Note that calculation accuracy of the Doppler frequencies dpf_{θn,j,Rbm} may be lowered due to a low signal to noise ratio (SNR) of the digital signal s_{θn,j}(t). In such a case, the Doppler frequency calculating unit 12 may increase the calculation accuracy of the Doppler frequencies dpf_{θn,j,Rbm} for example, by performing the following processing.

For example, the Doppler frequency calculating unit 12 acquires digital signals s_{θn,j}(t) related to a plurality of pulsed beams having the same elevation angle θₙ and different hit numbers, and converts the digital signals s_{θn,j}(t) related to the plurality of beams into frequency domain signals s_{θn,j}(f). Then, the Doppler frequency calculating unit 12 coherently integrates the signals s_{θn,j}(f) in the plurality of frequency domains to increase the calculation accuracy of the Doppler frequencies dpf_{θRbm}. Since the processing itself for enhancing the calculation accuracy of the Doppler frequencies dpf_{θn,j,Rbm} is a known technique, detailed description thereof will be omitted. The first wind speed distribution estimating unit 13 acquires the Doppler frequencies dpf_{θn,j,Rbm} of the respective range bins Rbₘ from the Doppler frequency calculating unit 12.

The first wind speed distribution estimating unit 13 estimates the wind speed distribution u_{Rbm}(x, y) in the two-dimensional plane corresponding to each range bin Rbₘ from the plurality of Doppler frequencies dpf_{θ1,j,Rbm} to dpf_{θN,j,Rbm} in each range bin Rbₘ using the VVP method (step ST5 in FIG. 6).

Hereinafter, estimation processing of the wind speed distribution u_{Rbm}(x, y) in the two-dimensional plane by the first wind speed distribution estimating unit 13 will be specifically described.

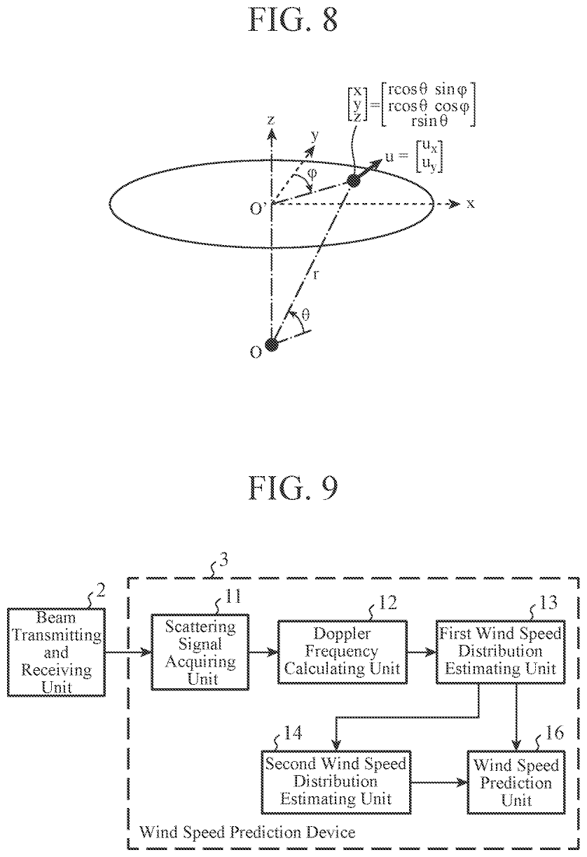

FIG. 8 is an explanatory diagram illustrating positions (x, y, z) of observation points of the wind speed.

The position (x, y, z) of the observation point of the wind speed is expressed by polar coordinates centered on the position O of the beam transmitting and receiving unit 2 included in the radar device 1 as expressed by the following Expression (1).

$$[ \begin{matrix}x \\ y \\ z\end{matrix} ] = [ \begin{matrix}r cos θ sin ϕ \\ r cos θ cos ϕ \\ r sin θ\end{matrix} ] \qquad ( 1 )$$

In Expression (1), θ is the elevation angle of a beam. φ is an angle formed by a line segment connecting the center point O′ of the x-y plane where the observation point is present and the position (x, y, z) of the observation point and they axis. r is a distance between the position O of the beam transmitting and receiving unit 2 and the position of the observation point (x, y, z).

For example, when the terrain of the ground surface vertically below the observation point is not a special terrain but a general terrain, there is no practical problem in observing the wind affecting the flying object as long as the wind speed prediction device 3 can observe the wind speed in a direction parallel to the two-dimensional plane even if the wind speed prediction device 3 cannot observe the wind speed in the vertical direction with respect to the two-dimensional plane where the observation point is present.

The general terrain corresponds to a flat terrain, an inclined terrain, a terrain having small irregularities, or the like. The special terrain corresponds to a terrain having a valley bottom, a terrain having a cliff with a large difference in elevation, or the like.

Accordingly, in the wind speed prediction device 3 illustrated in FIG. 3, the first wind speed distribution estimating unit 13 ignores the wind speed in the vertical direction, and a true wind speed vector u at the observation point is expressed as the following Expression (2).

$$u = [ \begin{matrix}{u}_{x} \\ {u}_{y}\end{matrix} ] \qquad ( 2 )$$

In Expression (2), uₓ represents a component in a direction parallel to the x-axis of the wind speed vector u, and u_{y} represents a component in a direction parallel to the y-axis of the wind speed vector u.

The first wind speed distribution estimating unit 13 performs Taylor expansion of the wind speed vector u centered on the center point O′ with respect to x and y on the assumption that the wind speed u₀ at the center point O′ of the x-y plane is expressed as the following Expression (3). For example, when the third and subsequent terms are ignored, the following approximate Expression (4) holds.

$${u}_{0} = {[ {u}_{x 0} , {u}_{y 0} ]}^{T} \qquad ( 3 )$$

$$u ( x , y ) ≃ {u}_{0} + ( \frac{\partial u}{\partial x} x + \frac{\partial u}{\partial y} y ) + \frac{1}{2} ( \frac{{\partial }^{2} u}{\partial {x}^{2}} {x}^{2} + 2 \frac{{\partial }^{2} u}{\partial x \partial y} xy + \frac{{\partial }^{2} u}{\partial {y}^{2}} {y}^{2} ) \qquad ( 4 )$$

Since what is observed by the radar device 1 is the speed in the line-of-sight direction of the wind speed at the observation point, an observed wind speed uᵣ(θ, φ) is expressed as the following Expression (5).

$$\begin{matrix}{u}_{r} ( θ , ϕ ) = u ( x , y ) \cdot ( {i}_{x} cos θ sin ϕ + {i}_{y} cos θ cos ϕ + {i}_{z} sin θ ) \\ = {a}_{θ , ϕ}^{T} \cdot p\end{matrix} \qquad ( 5 )$$

$${a}_{θ , ϕ} = [ \begin{matrix}cos θ sin ϕ , \\ cos θ cos ϕ , \\ r {cos}^{2} θ {sin}^{2} ϕ , \\ r {cos}^{2} θ sin ϕ cos ϕ , \\ r {cos}^{2} θ {cos}^{2} ϕ , \\ {r}^{2} {cos}^{3} θ {sin}^{3} ϕ , \\ {r}^{2} {cos}^{3} θ {sin}^{2} ϕ cos ϕ , \\ {r}^{2} {cos}^{3} θ sin ϕ {cos}^{2} ϕ , \\ {r}^{2} {cos}^{3} θ {cos}^{3} ϕ\end{matrix} ] \qquad ( 6 )$$

$$p = [ \begin{matrix}{u}_{x 0} , \\ {u}_{y 0} , \\ \frac{\partial {u}_{x}}{\partial x} , \\ \frac{\partial {u}_{x}}{\partial y} + \frac{\partial {u}_{y}}{\partial x} , \\ \frac{\partial {u}_{y}}{\partial y} , \\ \frac{{\partial }^{2} {u}_{x}}{\partial {x}^{2}} , \\ \frac{{\partial }^{2} {u}_{x}}{\partial x \partial y} + \frac{{\partial }^{2} {u}_{y}}{\partial {x}^{2}} , \\ \frac{{\partial }^{2} {u}_{x}}{\partial {y}^{2}} + \frac{{\partial }^{2} {u}_{y}}{\partial x \partial y} , \\ \frac{{\partial }^{2} {u}_{y}}{\partial {y}^{2}}\end{matrix} ] \qquad ( 7 )$$

The first wind speed distribution estimating unit 13 acquires the observed wind speeds uᵣ(θ₁, θ₁) to Uᵣ(θ_{K}, φ_{K}) of K beams, and substitutes the acquired observed wind speeds uᵣ(θ₁, θ₁) to Uᵣ(θ_{K}, φ_{K}) into the following Expression (8) to estimate p illustrated in Expression (7). K is an integer of 2 or more. The K beams are K pieces of pulsed light in which sets of the elevation angleθ and the angle φ are different from each other.

$$[ \begin{matrix}{u}_{r} ( {θ}_{1} , {ϕ}_{1} ) \\ {u}_{r} ( {θ}_{2} , {ϕ}_{2} ) \\ ⋮ \\ {u}_{r} ( {θ}_{K} , {ϕ}_{K} )\end{matrix} ] = [ \begin{matrix}{a}_{{θ}_{1} , {ϕ}_{1}}^{T} \\ {a}_{{θ}_{2} , {ϕ}_{2}}^{T} \\ ⋮ \\ {a}_{{θ}_{K} , {ϕ}_{K}}^{T}\end{matrix} ] p ⇒ p ≃ [ \begin{matrix}{a}_{{θ}_{1} , {ϕ}_{1}}^{T} \\ {a}_{{θ}_{2} , {ϕ}_{2}}^{T} \\ ⋮ \\ {a}_{{θ}_{K} , {ϕ}_{K}}^{T}\end{matrix} ] [ \begin{matrix}{u}_{r} ( {θ}_{1} , {ϕ}_{1} ) \\ {u}_{r} ( {θ}_{2} , {ϕ}_{2} ) \\ ⋮ \\ {u}_{r} ( {θ}_{K} , {ϕ}_{K} )\end{matrix} ] \qquad ( 8 )$$

A symbol “†” denotes pseudo-inverse matrix in Expression 8 In Expression (8), † is a symbol representing a pseudo-inverse matrix.

Among the elements of p illustrated in Expression (7), the fourth, seventh, and eighth elements from the top are expressed as the sum of two parameters, and thus are uncertain elements.

The first wind speed distribution estimating unit 13 determines the uncertain elements by equally allocating the parameter of the element of p estimated by Expression (8).

When the fourth element from the top among the elements of p is p₄, the first wind speed distribution estimating unit 13 determines p₄ as in the following Expression (9), for example.

When the seventh element from the top among the elements of p is p₇, the first wind speed distribution estimating unit 13 determines p₇ as in the following Expression (10), for example.

When the eighth element from the top among the elements of p is p₈, the first wind speed distribution estimating unit 13 determines p₈ as in the following Expression (11), for example.

$$\frac{\partial {u}_{x}}{\partial y} = \frac{\partial {u}_{y}}{\partial x} = \frac{1}{2} {p}_{4} \qquad ( 9 )$$

$$\frac{{\partial }^{2} {u}_{x}}{\partial x \partial y} = \frac{{\partial }^{2} {u}_{y}}{\partial {x}^{2}} = \frac{1}{2} {p}_{7} \qquad ( 10 )$$

$$\frac{{\partial }^{2} {u}_{x}}{\partial {y}^{2}} = \frac{{\partial }^{2} {u}_{y}}{\partial x \partial y} = \frac{1}{2} {p}_{8} \qquad ( 11 )$$

As described above, since all the coefficients u₀, ∂u/∂x, ∂u/∂y, ∂²u/∂x², ∂²u/∂x∂y, and ∂²u/∂y² illustrated in the approximate Expression (4) are determined, the first wind speed distribution estimating unit 13 can obtain the wind speed vector u(x, y) at each observation point from the approximate Expression (4).

When the wind speed vector u(x, y) at each observation point can be obtained, the first wind speed distribution estimating unit 13 can obtain the wind speed distribution u_{Rbm}(x, y) in the two-dimensional plane corresponding to each range bin Rbₘ.

Here, the first wind speed distribution estimating unit 13 approximates the Taylor expansion of the wind speed vector u(x, y) by 0th to 2nd order terms. However, this is merely an example, and the first wind speed distribution estimating unit 13 may approximate the Taylor expansion of the wind speed vector u(x, y) with terms of 0 degree to 3 degrees or more.

When M is 1, the first wind speed distribution estimating unit 13 outputs the wind speed distribution u_{Rb1}(x, y) in the two-dimensional plane corresponding to the range bin Rb₁ to the wind speed prediction unit 15.

When M is 2 or more, the first wind speed distribution estimating unit 13 outputs the wind speed distribution u_{Rbm}(x, y) in the two-dimensional plane corresponding to each range bin Rbₘ to the second wind speed distribution estimating unit 14.

The second wind speed distribution estimating unit 14 acquires the wind speed distribution u_{Rbm}(x, y) in the two-dimensional plane corresponding to each range bin Rbₘ from the first wind speed distribution estimating unit 13.

The second wind speed distribution estimating unit 14 estimates a wind speed distribution uR_{bm′}(x, y) in a two-dimensional plane between the plurality of two-dimensional planes from the wind speed distributions u_{Rb1}(x, y) to u_{Rbm}(x, y) in the plurality of two-dimensional planes (step ST6 in FIG. 6).

The second wind speed distribution estimating unit 14 outputs the wind speed distributions u_{Rb1′}(x, y) to u_{RbM-1′}(x, y) in the two-dimensional planes to the wind speed prediction unit 15.

Hereinafter, estimation processing of the wind speed distribution uR_{bm′}(x, y) in the two-dimensional plane by the second wind speed distribution estimating unit 14 will be specifically described.

For example, when estimating the wind speed distribution u_{Rbm′}(x, y) in the two-dimensional plane between the two-dimensional plane in which the wind speed distribution is u_{Rbm}(x, y) and a two-dimensional plane in which the wind speed distribution is u_{Rbm+1}(x, y), the second wind speed distribution estimating unit 14 calculates the distance L_{m-m′} in the vertical direction from the two-dimensional plane in which the wind speed distribution u_{Rbm′}(x, y) is estimated to the two-dimensional plane in which the wind speed distribution is u_{Rbm}(x, y).

Further, the second wind speed distribution estimating unit 14 calculates a distance L_{(m+1)-m′} in the vertical direction from the two-dimensional plane in which the wind speed distribution u_{Rbm′}(x, y) is estimated to the two-dimensional plane in which the wind speed distribution is u_{Rbm′1}(x, y).

The second wind speed distribution estimating unit 14 calculates a weighting coefficient wₘ for the wind speed distribution u_{Rbm}(x, y) in the two-dimensional plane and a weighting coefficient wₘ₊₁ for the wind speed distribution u_{Rbm+1}(x, y) in the two-dimensional plane on the basis of the distance Lₘ₋ₘ′ and the distance L_{(m+1)-m′} as expressed in the following Expressions (12) to (14).

$${w}_{m} = \frac{L - {L}_{m - m ′}}{L} \qquad ( 12 )$$

$${w}_{m + 1} = \frac{L - {L}_{( m + 1 ) - m ′}}{L} \qquad ( 13 )$$

$${L}_{m - m ′} + {L}_{( m + 1 ) - m ′} = L \qquad ( 14 )$$

The second wind speed distribution estimating unit 14 estimates the wind speed distribution u_{Rbm′}(x, y) in the two-dimensional plane between the two-dimensional plane in which the wind speed distribution is u_{Rbm}(x, y) and the two-dimensional plane in which the wind speed distribution is u_{Rbm+1}(x, y) on the basis of the weighting coefficient wₘ and the weighting coefficient wₘ₋₁ as expressed in the following Expression (15).

$${u}_{Rbm ′} ( x , y ) = \frac{{w}_{m} \times {u}_{Rbm} ( x , y ) + {w}_{m + 1} \times {u}_{Rbm + 1} ( x , y )}{{w}_{m} + {w}_{m + 1}} \qquad ( 15 )$$

Here, the second wind speed distribution estimating unit 14 estimates the wind speed distribution u_{Rbm′}(x, y) in the two-dimensional plane as a weighted average based on the distance from the two-dimensional plane in which the wind speed distribution u_{Rbm′}(x, y) is estimated. However, this is merely an example, and for example, the second wind speed distribution estimating unit 14 compares the distance L_{m-′} with the distance L_{(m+1)-m′}. When the distance L_{m-m′} is shorter than the distance L_{(m+1)-m′}, the second wind speed distribution estimating unit 14 may use the wind speed distribution u_{Rbm}(x, y) in the two-dimensional plane as the wind speed distribution u_{Rbm′}(x, y) in the two-dimensional plane, and when the distance L_{m-m′} is equal to or longer than the distance L_{(m+1)-m′}, the second wind speed distribution estimating unit 14 may use the wind speed distribution u_{Rbm+1}(x, y) in the two-dimensional plane as the wind speed distribution u_{Rbm′}(x, y) in the two-dimensional plane.

Further, here, the second wind speed distribution estimating unit 14 estimates the wind speed distribution u_{Rbm′}(x, y) in one two-dimensional plane as the wind speed distribution in the two-dimensional plane between the two-dimensional plane in which the wind speed distribution is R_{bm}(x, y) and the two-dimensional plane in which the wind speed distribution is u_{Rbm+1}(x, y). However, this is merely an example, and the second wind speed distribution estimating unit 14 may estimate wind speed distributions u_{Rbm}(x, y) of two or more two-dimensional planes having different positions in the vertical direction as the wind speed distribution in the two-dimensional plane between the two-dimensional plane in which the wind speed distribution is u_{Rbm}(x, y) and the two-dimensional plane in which the wind speed distribution is u_{Rbm+1}(x, y).

When M is 1, the wind speed prediction unit 15 acquires the wind speed distribution u_{Rb1}(x, y) in the two-dimensional plane from the first wind speed distribution estimating unit 13.

When M is 2 or more, the wind speed prediction unit 15 acquires the wind speed distributions u_{Rb1}(x, y) to u_{RbM}(x, y) in the plurality of two-dimensional planes from the first wind speed distribution estimating unit 13, and acquires wind speed distributions u_{Rb1}′(x, y) to u_{RbM-1′}(x, y) in the two-dimensional plane from the second wind speed distribution estimating unit 14.

When M is 1, the wind speed prediction unit 15 predicts the wind speed u(t) in the observation region in the two-dimensional plane from the wind speed distribution u_{Rb1}(x, y) in the two-dimensional plane using the two-dimensional N-S equation (step ST7 in FIG. 6).

When M is 2 or more, the wind speed prediction unit 15 selects the wind speed distribution in any two-dimensional plane from among the wind speed distributions u_{Rb1}(x, y) to u_{RbM}(x, y) in the plurality of two-dimensional planes and the wind speed distributions u_{Rb1′}(x, y) to u_{RbM-1′}(x, y) in the two-dimensional planes.

When the observation point of the prediction target of the wind speed u(t) is present in the observation region in the two-dimensional plane corresponding to the range bin Rbₘ, the wind speed prediction unit 15 selects the wind speed distribution u_{Rbm}(x, y). When the observation point of the prediction target of the wind speed u(t) is present in the observation region in the two-dimensional plane corresponding to the range bin Rb_{m′}, the wind speed prediction unit 15 selects the wind speed distribution u_{Rbm′}(x, y).

The wind speed prediction unit 15 predicts the wind speed u(t) in the observation region in the selected two-dimensional plane from the wind speed distribution in the selected two-dimensional plane using the two-dimensional N-S equation (step ST7 in FIG. 6).

Hereinafter, prediction processing of the wind speed u(t) performed by the wind speed prediction unit 15 will be specifically described.

Wind is generally considered an uncompressed fluid. The two-dimensional N-S equation regarding the uncompressed fluid is expressed by the following Expressions (16) and (17).

$$\frac{\partial u}{\partial t} = - ( u \cdot ∇ ) u + v Δ u - \frac{1}{ρ} ∇ p + f \qquad ( 16 )$$

$$∇ \cdot u = 0 \qquad ( 17 )$$

In Expression (16), u is a wind speed vector, v is a viscosity coefficient, ρ is a density, p is a pressure, f is an external force vector, and t is a time variable.

Since the viscosity coefficient v is very small, the viscosity of the wind can be ignored. In addition, the term of the external force vector F can also be ignored. Therefore, under the condition that each of the viscosity of the wind and the external force is absent, Expression (16) is expressed as the following Expression (18), and Expression (17) is expressed as the following Expression (19).

$$\frac{\partial u}{\partial t} = - ( u \cdot ∇ ) u - \frac{1}{ρ} ∇ p \qquad ( 18 )$$

$$∇ \cdot u = 0 \qquad ( 19 )$$

The first term on the right side of Expression (18) is referred to as an advection term, and the second term on the right side is referred to as a pressure term.

When the wind speed vector u is a two-dimensional vector u=[uₓ, u_{y}]^{T}, Expression (18) is expressed as the following Expressions (20) and (21).

$$\frac{\partial {u}_{x}}{\partial t} = - {u}_{x} \frac{\partial {u}_{x}}{\partial x} - {u}_{y} \frac{\partial {u}_{x}}{\partial y} - \frac{1}{ρ} \frac{\partial p}{\partial x} \qquad ( 20 )$$

$$\frac{\partial {u}_{y}}{\partial t} = - {u}_{x} \frac{\partial {u}_{y}}{\partial x} - {u}_{y} \frac{\partial {u}_{y}}{\partial y} - \frac{1}{ρ} \frac{\partial p}{\partial y} \qquad ( 21 )$$

$$\frac{\partial {u}_{x}}{\partial x} + \frac{\partial {u}_{y}}{\partial y} = 0 \qquad ( 22 )$$

When Expression (22) is used, Expression (20) is expressed as the following Expression (23), and Expression (21) is expressed as the following Expression (24).

$$\frac{\partial {u}_{x}}{\partial t} = - \frac{\partial {u}_{x}^{2}}{\partial x} - \frac{\partial {u}_{x} {u}_{y}}{\partial y} - \frac{1}{ρ} \frac{\partial p}{\partial x} \qquad ( 23 )$$

$$\frac{\partial {u}_{y}}{\partial t} = - \frac{\partial {u}_{x} {u}_{y}}{\partial x} - \frac{\partial {u}_{y}^{2}}{\partial y} - \frac{1}{ρ} \frac{\partial p}{\partial y} \qquad ( 24 )$$

When the wind speed vector u is discretized with respect to time by the difference method, Expression (23) is expressed as the following Expression (25), and Expression (24) is expressed as the following Expression (26).

$$\frac{{\partial }_{x}^{g + 1} - {u}_{x}^{g}}{dt} = - \frac{\partial {u}_{x}^{2}}{\partial x} - \frac{\partial {u}_{x} {u}_{y}}{\partial y} - \frac{1}{ρ} \frac{\partial p}{\partial x} \qquad ( 25 )$$

$$\frac{{u}_{y}^{g + 1} - {u}_{y}^{g}}{dt} = - \frac{\partial {u}_{x} {u}_{y}}{\partial x} - \frac{\partial {u}_{y}^{2}}{\partial y} - \frac{1}{ρ} \frac{\partial p}{\partial y} \qquad ( 26 )$$

In the Expressions (25) and (26), g and g+1 are symbols indicating time steps.

By using an intermediate variable uₓ*, Expression (25) can be divided into two Expressions as the following Expressions (27) and (28).

In addition, by using an intermediate variable u_{y}* , Expression (26) can be divided into two Expressions as the following Expressions (29) and (30).

$$\frac{{u}_{x}^{*} - {u}_{x}^{g}}{dt} = - \frac{\partial {u}_{x}^{2}}{\partial x} - \frac{\partial {u}_{x} {u}_{y}}{\partial y} \qquad ( 27 )$$

$$\frac{{u}_{x}^{g + 1} - {u}_{x}^{*}}{dt} = - \frac{1}{ρ} \frac{\partial p}{\partial x} \qquad ( 28 )$$

$$\frac{{u}_{y}^{*} - {u}_{y}^{g}}{dt} = - \frac{\partial {u}_{x} {u}_{y}}{\partial x} - \frac{\partial {u}_{y}^{2}}{\partial y} \qquad ( 29 )$$

$$\frac{{u}_{y}^{g + 1} - {u}_{y}^{*}}{dt} = - \frac{1}{ρ} \frac{\partial p}{\partial y} \qquad ( 30 )$$

Expression (27) is transformed as Expression (31), and Expression (29) is transformed as Expression (32).

$${u}_{x}^{*} = {u}_{x}^{g} - dt ( \frac{\partial {u}_{x}^{2}}{\partial x} + \frac{\partial {u}_{x} {u}_{y}}{\partial y} ) \qquad ( 31 )$$

$${u}_{y}^{*} = {u}_{y}^{g} - dt ( \frac{\partial {u}_{x} {u}_{y}}{\partial x} + \frac{\partial {u}_{y}^{2}}{\partial y} ) \qquad ( 32 )$$

Expression (28) is expressed as Expression (33) below when differentiated in the x direction, and Expression (30) is expressed as Expression (34) below when differentiated in the y direction.

$$\frac{\frac{\partial {u}_{x}^{g + 1}}{\partial x} - \frac{\partial {u}_{x}^{*}}{\partial x}}{dt} = - \frac{1}{ρ} \frac{{\partial }^{2} p}{\partial {x}^{2}} \qquad ( 33 )$$

$$\frac{\frac{\partial {u}_{y}^{g + 1}}{\partial y} - \frac{\partial {u}_{y}^{*}}{\partial y}}{dt} = - \frac{1}{ρ} \frac{{\partial }^{2} p}{\partial {y}^{2}} \qquad ( 34 )$$

When the left sides of Expressions (33) and (34) are added to each other and the right sides of Expressions (33) and (34) are added to each other, the following Expression (35) is obtained.

$$\frac{1}{dt} ( \frac{\partial {u}_{x}^{g + 1}}{\partial x} + \frac{\partial {u}_{y}^{g + 1}}{\partial y} - \frac{\partial {u}_{x}^{*}}{\partial x} - \frac{\partial {u}_{y}^{*}}{\partial y} ) = - \frac{1}{ρ} ( \frac{{\partial }^{2} p}{\partial {x}^{2}} + \frac{{\partial }^{2} p}{\partial {y}^{2}} ) \qquad ( 35 )$$

According to Expression (22), δ·u^{g+1}=0 needs to be satisfied for the estimated wind speed vector u at the next time step g+1. Therefore, the following Expression (36) is obtained as the Poisson's equation regarding pressure from Expression (35).

$$\frac{1}{ρ} ( \frac{{\partial }^{2} p}{\partial {x}^{2}} + \frac{{\partial }^{2} p}{\partial {y}^{2}} ) = \frac{1}{dt} ( \frac{\partial {u}_{x}^{*}}{\partial x} + \frac{\partial {u}_{y}^{*}}{\partial y} ) \qquad ( 36 )$$

The wind speed prediction unit 15 discretizes the wind speed vector u^{g}=[uₓ^{g}, u_{y}^{g}]^{T} at the current time step g in the spatial direction.

The wind speed prediction unit 15 calculates the intermediate variable uₓ* by substituting the discretized uₓ^{g} into Expression (31), and calculates the intermediate variable u_{y}* by substituting the discretized u_{y}^{g} into Expression (32).

The wind speed prediction unit 15 calculates the pressure p from Expression (36) using the intermediate variable uₓ* and the intermediate variable u_{y}*.

The wind speed prediction unit 15 calculates a wind speed vector uₓ^{g+1} of the next time step g+1 from Expression (28) using the intermediate variable uₓ* and the pressure p.

The wind speed prediction unit 15 calculates a wind speed vector u_{y}^{g+1} of the next time step g+1 from Expression (30) using the intermediate variable u_{y}* and the pressure p.

The wind speed u(t) predicted by the wind speed prediction unit 15 is [uₓ^{g+1}, u_{y}^{g+1}]^{T}, and the wind speed u(t) is displayed on, for example, a display (not illustrated).

A conventional wind speed prediction device performs a simulation using a weather model in order to predict a wind speed in an observation region, and the simulation using the weather model is three-dimensional calculation processing. For example, when the number of observation points in the three-dimensional observation region is Cx×Cy×Cz, and C=Cx=Cy=Cz, the calculation amount order is approximately proportional to C³.

On the other hand, the calculation processing of the wind speed prediction device 3 illustrated in FIG. 3 is two-dimensional calculation processing. For example, when the number of two-dimensional planes is M, the number of observation points in the observation region present in the two-dimensional plane is Cx×Cy, and C=Cx=Cy, the calculation amount order is approximately proportional to C²×M. When M=C, the calculation amount order of the wind speed prediction device 3 illustrated in FIG. 3 is substantially the same as the calculation amount order of the conventional wind speed prediction device.

However, it is assumed that three-dimensional calculation processing uses a three-dimensional N-S equation that does not ignore vertical wind. In the three-dimensional N-S equation, it is difficult to greatly expand the interval between the observation points in the vertical direction, and the maximum value of the interval between the observation points at which the three-dimensional N-S equation can be solved is determined as a Courant condition in the vertical direction.

On the other hand, in the two-dimensional N-S equation ignoring the vertical wind, which is the two-dimensional calculation processing, since there is no Courant condition in the vertical direction, it is possible to satisfy Cz 22 >M. For example, when (M/Cz)=1/Q, the calculation amount order of the wind speed prediction device 3 illustrated in FIG. 3 is approximately 1/Q of the calculation amount order of the conventional wind speed prediction device. Q is a value of about 10 to 1000.

As described above, for example, when the terrain of the ground surface vertically below the observation point is not a special terrain but a general terrain, there is no practical problem in observing the wind affecting the flying object as long as the wind speed prediction device 3 can observe the wind speed in the direction parallel to the two-dimensional plane even if the wind speed prediction device 3 cannot observe the wind speed in the vertical direction with respect to the two-dimensional plane where the observation point is present.

Even if the terrain of the ground surface vertically below the observation point is a special terrain, the wind speed in the direction parallel to the two-dimensional plane can be used as useful information for observing the wind affecting the flying object.

In a first embodiment described above, the wind speed prediction device 3 includes the scattering signal acquiring unit 11 to acquire a scattering signal that is each of a plurality of beams after being emitted to space and scattered in the space, the beams having mutually different elevation angles, which are angles formed by a line-of-sight direction and a horizontal direction, the Doppler frequency calculating unit 12 to set a range bin width as distance resolution of each of scattering signals acquired by the scattering signal acquiring unit 11 according to an elevation angle of each of the beams emitted to space, and calculate a Doppler frequency of a range bin corresponding to a two-dimensional plane including an observation region from the each of the scattering signals, the first wind speed distribution estimating unit 13 to estimate a wind speed distribution in the two-dimensional plane from a plurality of Doppler frequencies calculated by the Doppler frequency calculating unit 12 using a VVP method, and the wind speed prediction unit 15 to predict a wind speed in the observation region from the wind speed distribution in the two-dimensional plane estimated by the first wind speed distribution estimating unit 13 using a two-dimensional Navier-Stokes equation. Therefore, the wind speed prediction device 3 can predict the wind speed without performing three-dimensional calculation processing.

In the wind speed prediction device 3 illustrated in FIG. 3, the first wind speed distribution estimating unit 13 estimates the wind speed distribution u_{Rbm}(x, y) in the two-dimensional plane corresponding to each range bin Rbₘ. However, the wind speed distribution u_{Rbm}(x, y) estimated by the first wind speed distribution estimating unit 13 may slightly deviate from the actual wind speed distribution due to the influence of observation noise. The first wind speed distribution estimating unit 13 may smooth the wind speed distribution u_{Rbm}(x, y) in the time direction in order to suppress the deviation due to the influence of the observation noise.

The smoothing of the wind speed distribution u_{Rbm}(x, y) in the time direction can be implemented by fusing a fluid movement model such as a two-dimensional N-S equation and the estimated wind speed distribution u_{Rbm}(x, y). The fusion of the fluid movement model and the wind speed distribution u_{Rbm}(x, y) is called data assimilation.

For example, it is assumed that the true wind speed distribution u_{Rbm}(x, y) at the previous time step g−1 is represented by u_{t=tg-1}, and the true wind speed distribution u_{Rbm}(x, y) at the current time step g is represented by u_{t=tg}. The two-dimensional N-S equation is a fluid model that can nonlinearly describe the relationship between u_{t=tg-1} and u_{t=tg}, and if a nonlinear function is represented by f(108 ) the following Expression (37) holds.

uₜ₌ₜ_{ₙ}=ƒ(uₜ₌ₜ_{_{n−1}}) (37)

The data assimilation processing is processing performed using a data assimilation function As(⋅) as expressed in the following Expression (38). That is, the data assimilation processing calculates a smoothed u(x, y; t=tg) bar of the current time step g by adding u_{Rbm}(x, y; t=tg) which is the wind speed distribution u_{Rbm}(x, y) of the current time step g and f(u(x, y; t=tg−1) bar) obtained by time-developing the wind speed distribution u_{Rbm}(x, y) of the previous time step g−1 to the current time step g. In the text of the specification, since it is not possible to attach a symbol “−” above a character due to the electronic application, for example, it is written as a u(x, y; t=tg) bar.

u̅(̅x̅,̅ y̅;̅ t̅=̅t̅_̅{̅g̅}̅)̅=As (u(x, y; t=t_{g}), ƒ(̅u̅(̅x̅,̅ y̅;̅ t̅=̅t̅_̅{̅g̅-̅1̅}̅)̅)̅) (38)

Here, the first wind speed distribution estimating unit 13 performs the data assimilation processing using the data assimilation function As(⋅). However, this is merely an example, and the first wind speed distribution estimating unit 13 may perform the data assimilation processing by, for example, a particle filter using a two-dimensional N-S equation or an ensemble Kalman filter using the two-dimensional N-S equation. In addition, the first wind speed distribution estimating unit 13 may perform the data assimilation processing by an extended Kalman filter in which the two-dimensional N-S equation is approximated to a linear function or a variational method using the two-dimensional N-S equation.

### Second Embodiment

In the wind speed prediction device 3 according to the first embodiment, the wind speed prediction unit 15 selects the wind speed distribution in any two-dimensional plane from among the wind speed distributions u_{Rb1}(x, y) to u_{RbM}(x, y) in the plurality of two-dimensional planes and the wind speed distributions u_{Rb1′}(x, y) to u_{RbM-1′}(x, y) in the two-dimensional planes.

In a second embodiment, a wind speed prediction device 3 including a wind speed prediction unit 16 will be described, the wind speed prediction unit 16 estimating a wind speed distribution in a two-dimensional plane including a flight area in which a flying object is scheduled to fly as an observation region from the wind speed distributions u_{Rb1}(x, y) to u_{RbM}(x, y) in the plurality of two-dimensional planes and the wind speed distributions u_{Rb1′}(x, y) to u_{RbM-1′}(x, y) in the two-dimensional planes.

FIG. 9 is a configuration diagram illustrating the wind speed prediction device 3 according to the second embodiment. In FIG. 9, the same reference numerals as those in FIG. 3 denote the same or corresponding parts, and thus description thereof is omitted.

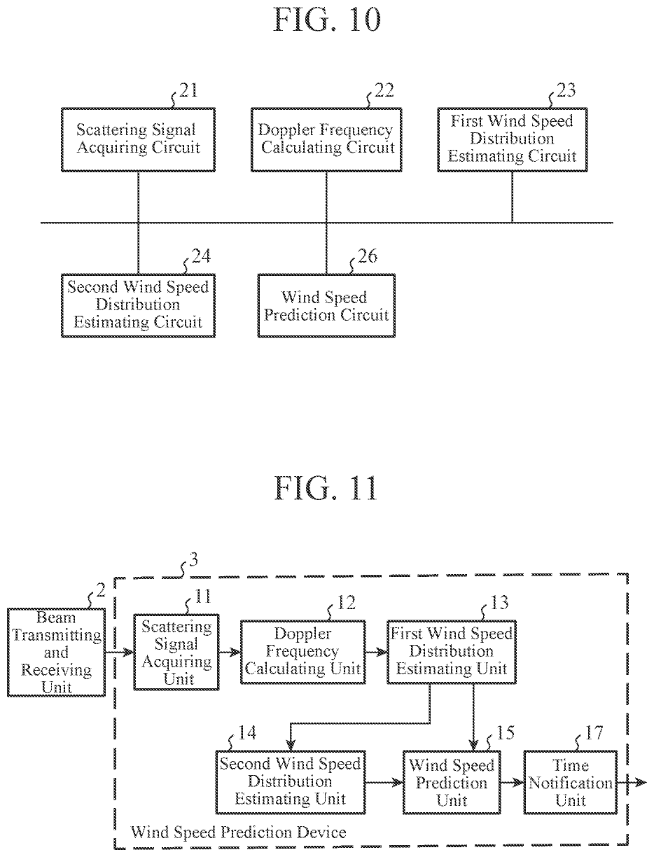

FIG. 10 is a hardware configuration diagram illustrating hardware of the wind speed prediction device 3 according to the second embodiment. In FIG. 10, the same reference numerals as those in FIG. 4 denote the same or corresponding parts, and thus description thereof is omitted.

The wind speed prediction device 3 illustrated in FIG. 9 includes a scattering signal acquiring unit 11, a Doppler frequency calculating unit 12, a first wind speed distribution estimating unit 13, a second wind speed distribution estimating unit 14, and the wind speed prediction unit 16.

The wind speed prediction unit 16 is implemented by, for example, a wind speed prediction circuit 26 illustrated in FIG. 10.

The wind speed prediction unit 16 estimates a wind speed distribution in a two-dimensional plane including a flight area as an observation region from the wind speed distributions u_{Rb1}(x, y) to u_{RbM}(x, y) in the plurality of two-dimensional planes estimated by the first wind speed distribution estimating unit 13 and the wind speed distributions u_{Rb1′}(x, y) to u_{RbM-1′}(x, y) in the two-dimensional plane estimated by the second wind speed distribution estimating unit 14.

The wind speed prediction unit 16 predicts the wind speed u(t) in the flight area from the estimated wind speed distribution in the two-dimensional plane using the two-dimensional N-S equation.

In FIG. 9, it is assumed that each of the scattering signal acquiring unit 11, the Doppler frequency calculating unit 12, the first wind speed distribution estimating unit 13, the second wind speed distribution estimating unit 14, and the wind speed prediction unit 16, which are components of the wind speed prediction device 3, is implemented by dedicated hardware as illustrated in FIG. 10. That is, it is assumed that the wind speed prediction device 3 is implemented by the scattering signal acquiring circuit 21, the Doppler frequency calculating circuit 22, the first wind speed distribution estimating circuit 23, the second wind speed distribution estimating circuit 24, and the wind speed prediction circuit 26.

Each of the scattering signal acquiring circuit 21, the Doppler frequency calculating circuit 22, the first wind speed distribution estimating circuit 23, the second wind speed distribution estimating circuit 24, and the wind speed prediction circuit 26 corresponds to, for example, a single circuit, a composite circuit, a programmed processor, a parallel-programmed processor, ASIC, FPGA, or a combination thereof.

The components of the wind speed prediction device 3 are not limited to those implemented by dedicated hardware, and the wind speed prediction device 3 may be implemented by software, firmware, or a combination of software and firmware.

In a case where the wind speed prediction device 3 is implemented by software, firmware, or the like, a program for causing a computer to execute each processing procedure in the scattering signal acquiring unit 11, the Doppler frequency calculating unit 12, the first wind speed distribution estimating unit 13, the second wind speed distribution estimating unit 14, and the wind speed prediction unit 16 is stored in the memory 31 illustrated in FIG. 5. Then, the processor 32 illustrated in FIG. 5 executes the program stored in the memory 31.

Further, FIG. 10 illustrates an example in which each of the components of the wind speed prediction device 3 is implemented by dedicated hardware, and FIG. 5 illustrates an example in which the wind speed prediction device 3 is implemented by software, firmware, or the like. However, this is merely an example, and some components in the wind speed prediction device 3 may be implemented by dedicated hardware, and the remaining components may be implemented by software, firmware, or the like.

Next, the operation of the wind speed prediction device 3 illustrated in FIG. 9 will be described. The wind speed prediction device 3 is similar to the wind speed prediction device 3 illustrated in FIG. 3 except for the wind speed prediction unit 16, and thus only the operation of the wind speed prediction unit 16 will be described here.

Here, for convenience of description, it is assumed that the flight area is present in a two-dimensional plane between a two-dimensional plane in which the wind speed distribution is u_{Rbm}(x, y) and a two-dimensional plane in which the wind speed distribution is u_{Rbm′}(x, y).

The wind speed prediction unit 16 calculates a distance Lₚ₋ₘ in the vertical direction from the two-dimensional plane in which the flight area is present to the two-dimensional plane in which the wind speed distribution is u_{Rbm}′(x, y).

Further, the wind speed prediction unit 16 calculates a distance L_{p-m′} in the vertical direction from the two-dimensional plane in which the flight area is present to the two-dimensional plane in which the wind speed distribution is u_{Rbm′}(x, y).

The wind speed prediction unit 16 calculates a weighting coefficient wₚ₋ₘ for the wind speed distribution u_{Rbm′}(x, y) in the two-dimensional plane and a weighting coefficient w_{p-m′} for the wind speed distribution u_{Rbm′}(x, y) in the two-dimensional plane on the basis of the distance Lₚ₋ₘ and the distance L_{p-m′} as expressed in the following Expressions (39) to (41).

$${w}_{p - m} = \frac{{L}^{′} - {L}_{p - m}}{{L}^{′}} \qquad ( 39 )$$

$${w}_{p - m ′} = \frac{{L}^{′} - {L}_{p - m ′}}{{L}^{′}} \qquad ( 40 )$$

$${L}_{p - m} + {L}_{p - m ′} = {L}^{′} \qquad ( 41 )$$

The wind speed prediction unit 16 estimates the wind speed distribution u_{Rbp}(X, y) of the two-dimensional plane where the flight area is present on the basis of the weighting coefficient wₚ₋ₘ and the weighting coefficient w_{p-m′} as expressed in the following Expression (42).

$${u}_{Rbp} ( x , y ) = \frac{{w}_{p - m} \times {u}_{Rbm} ( x , y ) + {w}_{p - m ′} \times {u}_{Rbm ′} ( x , y )}{{w}_{p - m} + {w}_{p - m ′}} \qquad ( 42 )$$

The wind speed prediction unit 16 predicts the wind speed u(t) in the flight area from the estimated wind speed distribution u_{Rbp}(x, y) in the two-dimensional plane using the two-dimensional N-S equation. The prediction processing of the wind speed u(t) performed by the wind speed prediction unit 16 is similar to the prediction processing of the wind speed u(t) performed by the wind speed prediction unit 15 illustrated in FIG. 3.

### Third Embodiment

In a third embodiment, a wind speed prediction device 3 including a time notification unit 17 that calculates a time t at which the wind speed u(t) predicted by the wind speed prediction unit 15 becomes equal to or higher than the threshold Th and gives a notification of the time t will be described.

FIG. 11 is a configuration diagram illustrating the wind speed prediction device 3 according to the third embodiment. In FIG. 11, the same reference numerals as those in FIGS. 3 and 9 denote the same or corresponding parts, and thus description thereof is omitted.

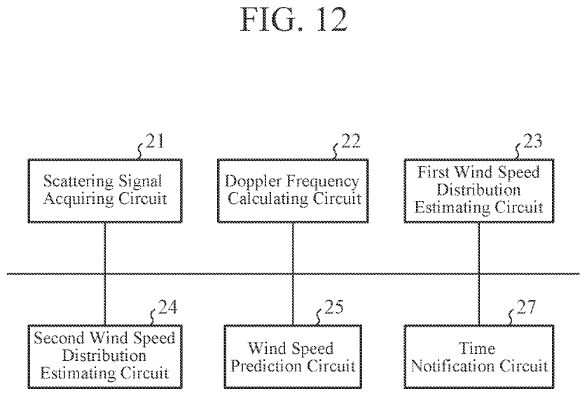

FIG. 12 is a hardware configuration diagram illustrating hardware of the wind speed prediction device 3 according to the third embodiment. In FIG. 12, the same reference numerals as those in FIGS. 4 and 10 denote the same or corresponding parts, and thus description thereof is omitted.

The wind speed prediction device 3 illustrated in FIG. 11 includes a scattering signal acquiring unit 11, a Doppler frequency calculating unit 12, a first wind speed distribution estimating unit 13, a second wind speed distribution estimating unit 14, the wind speed prediction unit 15, and the time notification unit 17.

The time notification unit 17 is implemented by, for example, a time notification circuit 27 illustrated in FIG. 12.

The time notification unit 17 specifies the time t at which the wind speed u(t) predicted by the wind speed prediction unit 15 becomes equal to or higher than the threshold Th.

The time notification unit 17 gives a notification of the specified time t to, for example, a flying object or a control tower monitoring a flight state of the flying object.

FIG. 11 illustrates an example in which the time notification unit 17 is applied to the wind speed prediction device 3 illustrated in FIG. 3. However, this is merely an example, and the time notification unit 17 may be applied to the wind speed prediction device 3 illustrated in FIG. 9.

In FIG. 11, it is assumed that each of the scattering signal acquiring unit 11, the Doppler frequency calculating unit 12, the first wind speed distribution estimating unit 13, the second wind speed distribution estimating unit 14, the wind speed prediction unit 15, and the time notification unit 17, which are components of the wind speed prediction device 3, is implemented by dedicated hardware as illustrated in FIG. 12. That is, it is assumed that the wind speed prediction device 3 is implemented by the scattering signal acquiring circuit 21, the Doppler frequency calculating circuit 22, the first wind speed distribution estimating circuit 23, the second wind speed distribution estimating circuit 24, the wind speed prediction circuit 25, and the time notification circuit 27.

Each of the scattering signal acquiring circuit 21, the Doppler frequency calculating circuit 22, the first wind speed distribution estimating circuit 23, the second wind speed distribution estimating circuit 24, the wind speed prediction circuit 25, and the time notification circuit 27 corresponds to, for example, a single circuit, a composite circuit, a programmed processor, a parallel-programmed processor, ASIC, FPGA, or a combination thereof.

The components of the wind speed prediction device 3 are not limited to those implemented by dedicated hardware, and the wind speed prediction device 3 may be implemented by software, firmware, or a combination of software and firmware.

In a case where the wind speed prediction device 3 is implemented by software, firmware, or the like, a program for causing a computer to execute each processing procedure in the scattering signal acquiring unit 11, the Doppler frequency calculating unit 12, the first wind speed distribution estimating unit 13, the second wind speed distribution estimating unit 14, the wind speed prediction unit 15, and the time notification unit 17 is stored in the memory 31 illustrated in FIG. 5. Then, the processor 32 illustrated in FIG. 5 executes the program stored in the memory 31.

Further, FIG. 12 illustrates an example in which each of the components of the wind speed prediction device 3 is implemented by dedicated hardware, and FIG. 5 illustrates an example in which the wind speed prediction device 3 is implemented by software, firmware, or the like. However, this is merely an example, and some components in the wind speed prediction device 3 may be implemented by dedicated hardware, and the remaining components may be implemented by software, firmware, or the like.

Next, the operation of the wind speed prediction device 3 illustrated in FIG. 11 will be described. The wind speed prediction device 3 is similar to the wind speed prediction device 3 illustrated in FIG. 3 except for the time notification unit 17, and thus only the operation of the time notification unit 17 will be described here.

The time notification unit 17 acquires the predicted wind speed u(t) from the wind speed prediction unit 15 every time the wind speed prediction unit 15 predicts the wind speed u(t).

Every time the predicted wind speed u(t) is acquired, the time notification unit 17 compares the wind speed u(t) with the threshold Th. The threshold Th is, for example, a lower limit value of the wind speed that may affect the flight of the flying object. The threshold Th may be stored in the internal memory of the time notification unit 17 or may be given from the outside.

The time notification unit 17 specifies the time t at which the wind speed u(t) is equal to or higher than the threshold Th on the basis of the comparison result between the wind speed u(t) and the threshold Th.

The time notification unit 17 gives a notification of the specified time t to, for example, a flying object or a control tower monitoring a flight state of the flying object.

In the third embodiment described above, the wind speed prediction device 3 illustrated in FIG. 11 includes the time notification unit 17 that specifies the time at which the wind speed predicted by the wind speed prediction unit 15 becomes equal to or higher than the threshold and gives a notification of the specified time t. Therefore, the wind speed prediction device 3 illustrated in FIG. 11 can predict the wind speed without performing three-dimensional calculation processing, as does the wind speed prediction device 3 illustrated in FIG. 3. In addition, it is possible to notify the time when wind that may affect the flight of the flying object blows.

Note that, in the present disclosure, free combinations of the embodiments, modifications of any components of the embodiments, or omissions of any components in the embodiments are possible.

### INDUSTRIAL APPLICABILITY

The present disclosure is suitable for a wind speed prediction device, a wind speed prediction method, and a radar device.

### REFERENCE SIGNS LIST

1: radar device, 2: beam transmitting and receiving unit, 3: wind speed prediction device, 11: scattering signal acquiring unit, 12: Doppler frequency calculating unit, 13: first wind speed distribution estimating unit, 14: second wind speed distribution estimating unit, 15, 16: wind speed prediction unit, 17: time notification unit, 21: scattering signal acquiring circuit, 22: doppler frequency calculating circuit, 23: first wind speed distribution estimating circuit, 24: second wind speed distribution estimating circuit, 25, 26: wind speed prediction circuit, 27: time notification circuit, 31: memory, 32: processor

1. A wind speed prediction device, comprising:
processing circuitry configured to
acquire a scattering signal that is each of a plurality of beams after being emitted to space and scattered in the space, the beams having mutually different elevation angles, which are angles formed by a line-of-sight direction and a horizontal direction;
variably set a range bin width as distance resolution of each of scattering signals having been acquired in accordance with an elevation angle of each of the beams emitted to the space to enable monitoring of an observation point at a same altitude even by a beam having a different elevation angle, and calculate at least one Doppler frequency of at least one range bin corresponding to a two-dimensional plane including an observation region from the each of the scattering signals, the at least one Doppler frequency including a plurality of Doppler frequencies;
estimate at least one wind speed distribution in the two-dimensional plane from the plurality of Doppler frequencies having been calculated using a volume velocity processing (VVP) method; and
predict a wind speed in the observation region from the estimated at least one wind speed distribution in the two-dimensional plane using a two-dimensional Navier-Stokes equation.

2. The wind speed prediction device according to claim 1, wherein the at least one range bin includes a plurality of range bins, and
the processing circuitry is configured to calculate each of Doppler frequencies in the plurality of range bins from the each of the scattering signals to express a three-dimensional region to be observed as a stack of the plurality of two-dimensional planes, and
estimate at least one wind speed distribution in a two-dimensional plane having a different altitude corresponding to each of the range bins corresponding to the two-dimensional planes having different altitudes using the VVP method from the plurality of the Doppler frequencies in each of the range bins, the at least one wind speed distribution including a plurality of wind speed distributions.

3. The wind speed prediction device according to claim 2, wherein
the processing circuitry is configured to select the at least one wind speed distribution in the two-dimensional plane having an altitude closest to a flight altitude at which a flying object is scheduled to fly from among the estimated wind speed distributions in the plurality of two-dimensional planes having different altitudes, and predict the wind speed in the flight area at which the flying object is scheduled to fly, from the selected at least one wind speed distribution using a two-dimensional Navier-Stokes equation.

4. The wind speed prediction device according to claim 2, wherein
the processing circuitry is configured to estimate the at least one wind speed distribution in the two-dimensional plane between the plurality of two-dimensional planes from the estimated wind speed distributions in the plurality of two-dimensional planes having different altitudes, and estimate a two-dimensional wind speed distribution having a designated altitude by interpolating the at least one wind speed distribution in the two-dimensional plane in an altitude direction, wherein
the processing circuitry is further configured to estimate the at least one wind speed distribution in the two-dimensional plane at a flight altitude at which a flying object is scheduled to fly, and predict a wind speed in the flight area at which the flying object is scheduled to fly, from the estimated wind speed distribution using a two-dimensional Navier-Stokes equation.

5. The wind speed prediction device according to claim 1, wherein the processing circuitry is configured to specify a time at which the predicted wind speed is equal to or higher than a threshold and gives a notification of the time.

6. A wind speed prediction method comprising, when each of a plurality of beams having mutually different elevation angles, which are angles formed by a line-of-sight direction and a horizontal direction, is emitted to space:
acquiring a scattering signal that is each of the beams after being scattered in the space;
variably setting a range bin width as distance resolution of each of scattering signals having been acquired in accordance with an elevation angle of each of the beams emitted to the space to enable monitoring of an observation point at a same altitude even by a beam having a different elevation angle;
calculating at least one Doppler frequency of at least one range bin corresponding to a two-dimensional plane including an observation region from the each of the scattering signals, the at least one Doppler frequency including a plurality of Doppler frequencies;
estimating at least one wind speed distribution in the two-dimensional plane from the plurality of Doppler frequencies having been calculated using a volume velocity processing (VVP) method; and
predicting a wind speed in the observation region from the estimated at least one wind speed distribution in the two-dimensional plane using a two-dimensional Navier-Stokes equation.

7. A radar device, comprising:
a beam transceiver to emit each of a plurality of beams having mutually different elevation angles, which are angles formed by a line-of-sight direction and a horizontal direction, to space and receive a scattering signal that is each of the beams after being scattered in the space;
processing circuitry configured to
acquire each of scattering signals received by the beam transceiver;
variably set a range bin width as distance resolution of each of scattering signals having been acquired in accordance with an elevation angle of each of the beams emitted from the beam transceiver to the space to enable monitoring of an observation point at a same altitude even by a beam having a different elevation angle, and calculate at least one Doppler frequency of at least one range bin corresponding to a two-dimensional plane including an observation region from the each of the scattering signals, the at least one Doppler frequency including a plurality of Doppler frequencies;
estimate at least one wind speed distribution in the two-dimensional plane from a plurality of Doppler frequencies having been calculated using a volume velocity processing (VVP) method; and
predict a wind speed in the observation region from the estimated at least one wind speed distribution in the two-dimensional plane using a two-dimensional Navier-Stokes equation.
